(19) United States
(12) Patent Application Publication
(10) Pub. No.: US 2015/0356164 A1
(43) Pub. Date: Dec. 10, 2015

(54) METHOD AND DEVICE FOR CLUSTERING FILE

(71) Applicant: Tencent Technology (Shenzhen) Company Limited, Shenzhen (CN)

(72) Inventors: Yi YANG, Shenzhen (CN); Tao YU, Shenzhen (CN); Bo TAO, Shenzhen (CN)

(73) Assignee: Tencent Technology (Shenzhen) Company Limited

(21) Appl. No.: 14/828,218

(22) Filed: Aug. 17, 2015

Related U.S. Application Data
(63) Continuation of application No. PCT/CN2013/087948, filed on Nov. 27, 2013.

(30) Foreign Application Priority Data
Feb. 21, 2013 (JP) 201310055669.6

(51) Int. Cl. G06F 17/30

(52) U.S. Cl. CPC G06F 17/30598; G06F 17/30115; G06F 17/30138

(57) ABSTRACT

In a method and a device for clustering files of the present application, to cluster files to be processed, information fingerprints of the files to be processed are obtained by processing information fingerprints of features of a plurality of information blocks contained in the file to be processed and are compared, and files to be processed with the same information fingerprint are taken as one cluster, so as to realize the clustering of files. The features of the information blocks in the files to be processed are identified by means of information fingerprints in this way, and then clustering is performed according to identifiers. Compared to prior art method using similarity comparisons, the method and device of the present application, which calculate and cluster an identifier of a feature, greatly reduce the data to be calculated and the degree of complexity.

### RELATED APPLICATION

This application is a continuation of International Application No. PCT/CN2013/087948, filed on Nov. 27, 2013, which claims priority to Chinese Patent Application No. 201310055669.6, filed with the Chinese Patent Office on Feb. 21, 2013 and entitled “METHOD AND DEVICE FOR CLUSTERING FILE”, both of which are hereby incorporated by reference in their entireties.

### FIELD OF THE TECHNOLOGY

The present disclosure relates to the field of information processing technologies, and particularly, relates to a method and device for clustering a file.

### BACKGROUND OF THE DISCLOSURE

With the development of the Internet, information increases explosively, where information on malicious computer programs such as computer viruses, worms, Trojan horses, and the like endanger security of user equipment every day. Files of most malicious programs are in portable executable (PE) format.

### SUMMARY

Embodiments of the present disclosure provide a file clustering method and device, so as to reduce complexity of file clustering.

An embodiment of the present disclosure provides a method for clustering a file, including:

extracting a feature from each of multiple information blocks in a respective file to be processed;

calculating an information fingerprint of the extracted feature of each information block of the multiple information blocks;
obtaining an information fingerprint of the respective file to be processed, according to the information fingerprint of the feature of each information block; and

outputting files to be processed with the same information fingerprint, as a cluster.

An embodiment of the present disclosure provides a device for clustering a file, including:

a feature extracting unit, configured to extracting a feature from each of multiple information blocks in a respective file to be processed;

a first fingerprint calculating unit, configured to calculate an information fingerprint of the extracted feature of each information block of the multiple information blocks;

a second fingerprint calculating unit, configured to obtain an information fingerprint of the respective file to be processed, according to the information fingerprint of the feature of each information block; and

a cluster output unit, configured to output files to be processed with the same information fingerprint, as a cluster.

In the embodiments of the present disclosure, when the files to be processed are clustered, the information fingerprints of the features of the multiple information blocks included in the respective file to be processed may be processed to obtain the information fingerprint of the respective file to be processed. Then, information fingerprints of files to be processed are compared to determine the files to be processed with the same information fingerprint as a cluster, so as to implement the file clustering. Therefore, the information fingerprints are used to identify the features of the information blocks in the files to be processed, and the files to be processed are clustered according to identifiers. Compared with the existing technology using similarity comparisons, the method for calculating the identifier of the feature to perform the clustering in the embodiments of the present disclosure significantly reduce the data to be calculated and the degree of complexity.

### BRIEF DESCRIPTION OF THE DRAWINGS

To describe the technical solutions of the embodiments of the present disclosure or the existing technology more clearly, the following briefly introduces the accompanying drawings required for describing the embodiments or the existing technology. Apparently, the accompanying drawings in the following description show only some embodiments of the present disclosure, and a person of ordinary skill in the art may still derive other drawings from these accompanying drawings without creative efforts.

FIG. 1 illustrates a flowchart of a method for clustering a file according to an embodiment of the present disclosure;

FIG. 2 illustrates a schematic diagram of data in a .text section included in a PE file according to an embodiment of the present disclosure;

FIG. 3 illustrates a flowchart of another method for clustering a file according to an embodiment of the present disclosure;

FIG. 4 illustrates a flowchart of a method for clustering a PE file according to an embodiment of the present disclosure;

FIG. 5 illustrates a schematic diagram of a device for clustering a file according to an embodiment of the present disclosure;

FIG. 6 illustrates a schematic diagram of a device for clustering a file according to an embodiment of the present disclosure; and

FIG. 7 illustrates a schematic diagram of a device for clustering a file according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by persons of ordinary skill in the art based on the embodiments of the present disclosure without creative efforts shall fall within the protection scope of the present disclosure.

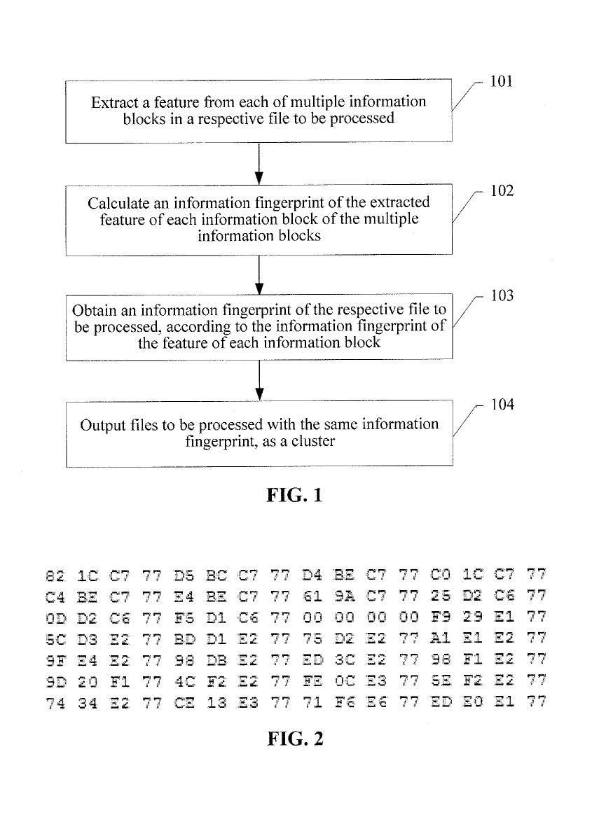

An embodiment of the present disclosure provides a method for clustering a file, for example, a method for clustering PE files. The method is mainly executed by a computer, a flowchart of which is shown in FIG. 1. The method includes steps 101 to 104.

Step 101: Extract a feature from each of multiple information blocks in a respective file to be processed.

It can be understood that each file may be divided into multiple information blocks. For a PE file, the PE file may be used in various operating systems and architectures, and may be encapsulated in information required by an operating system for loading an executable program code. The information includes a dynamic link library, an import table, an export table, resource management data, thread local storage data. Most malicious programs are PE files. A PE file may be divided into multiple information blocks, called sections, such as a .text section, a .data section, a .rsrc section, a .reloc section, and the like. Each section includes data with the same attribute, which may specifically be data between data 0 (00) to data 255 (FF).

The computer may extract features from all or some of the information blocks in the files to be processed. When extracting a feature from an information block, the computer may extract data distribution information of the information block. The data distribution information may indicate a distribution status of data in the information block. For example, the data distribution information may include frequencies and/or quantities of some or all data, such as, the occurrence frequency of data 1C and the quantity of the data 1C. As shown in FIG. 2, in data of the .text section, data 77 has a relatively high occurrence frequency.

Step 102: Calculate an information fingerprint of the feature of each information block of the multiple information blocks, extracted in step 101. An information fingerprint of an information block is a random number obtained by processing the information block, and the random number is used as an identifier of the information block distinguished from other information blocks. Common methods for calculating the information fingerprint include locality-sensitive hashing. In the embodiment of the present disclosure, the obtained information fingerprint may identify the feature of the information block.

Step 103: Obtain an information fingerprint of the respective file to be processed according to the information fingerprint of the feature of each information block. The information fingerprint of the file to be processed may be obtained by splicing the information fingerprint of the feature of each information block; or by other manners. The information fingerprint of the file to be processed includes the information fingerprint of the feature of each information block obtained in step 102.

Step 104: Output files to be processed which have the same information fingerprint and are obtained in step 103, as a cluster.

In the embodiment of the present disclosure, when the files to be processed are clustered, the information fingerprints of the features of the multiple information blocks included in the respective file to be processed may be processed to obtain the information fingerprint of the respective file to be processed. Then, information fingerprints of files to be processed are compared to determine the files to be processed with the same information fingerprint as a cluster, so as to implement the file clustering. Therefore, the information fingerprints are used to identify the features of the information blocks in the respective file to be processed, and the files to be processed are clustered according to identifiers. Compared with the existing technology using similarity comparisons, the method for calculating the identifier of the feature to perform the clustering in the embodiments of the present disclosure significantly reduces the data to be calculated and the degree of complexity.

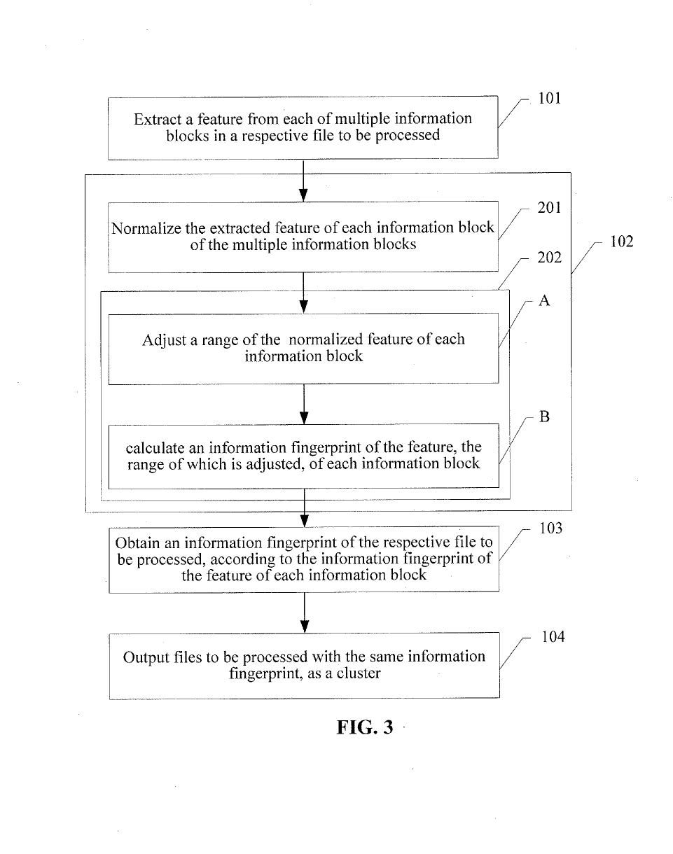

As shown in FIG. 3, in a specific embodiment, a computer may perform the following steps to implement the foregoing step 102.

Step 201: Normalize the feature of each information block of the multiple information blocks extracted in step 101, so as to unify the feature of each information block into data that may be relatively conveniently calculated.

Step 202: Calculate an information fingerprint of the normalized feature of each information block.

The computer may calculate the information fingerprint according to a calculation function of the information fingerprint directly, or by performing the following steps A and B.

Step A: Adjust a range of the normalized feature of each information block.

The range may be adjusted by kernel space mapping or weighting, and then a difference between features of information blocks may be narrowed or magnified according to actual situations. For example, if the difference between the features of two information blocks is 100, the range adjustment in this step is performed to narrow the difference between the features of the two information blocks to 20, thereby further reducing the calculation complexity.

When the adjustment is performed in the kernel space mapping method, according to a mapping function of a kernel space, the normalized feature of each information block is mapped to a kernel space corresponding to the mapping function, and information blocks with a same attribute in different files to be processed use the same mapping function. For example, .text sections in different PE files to be processed use the same mapping function. Different information blocks in one file to be process may use a same mapping function or different mapping functions.

When the adjustment is performed in the weighted method, the computer may perform a weighted operation on the normalized feature of each information block. Weighted values corresponding to different information blocks may be the same or may be different.

Step B: Calculate an information fingerprint of the feature, the range of which is adjusted, of each information block.

The information fingerprint corresponding to each information block may be calculated according to a certain information fingerprint calculation function.

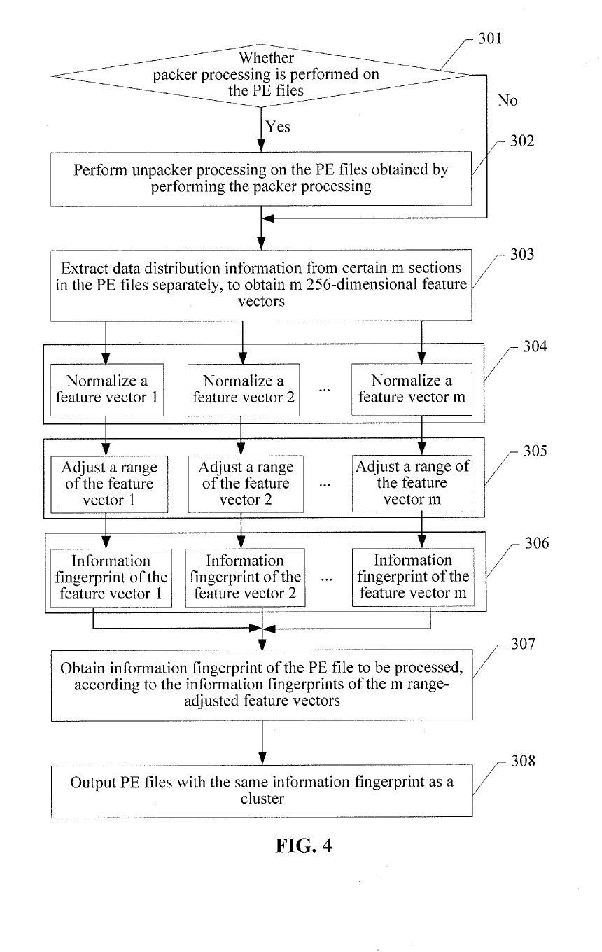

The method for clustering the file in the embodiment of the present disclosure may be illustrated in conjunction with an embodiment. This embodiment mainly describes that a computer clusters hexadecimal PE files. As shown in FIG. 4, the method includes steps 301-308.

Step 301: Determine whether a packer processing is performed on the PE file, that is, whether the PE file is a code-changed PE file which is obtained by a series of mathematical operations. If yes, the step 302 is performed, and if no, the step 303 is performed.

Step 302: Perform an unpacker processing on the PE file obtained by performing the packer processing, that is, remove packer protection from the PE files. The unpacker processing and the packer processing in step 301 are inverse. Then, the step 303 is performed.

Step 303: Extract data distribution information from certain m sections in the PE files separately.

For example, according to distribution frequencies of data between 0 (00) to 255 (FF) in respective sections, m 256-dimensional feature vectors are obtained, which are recorded as Hi=[h0, h1, . . . , h255], i=1, . . . , m, where Hi may indicate the distribution frequency of each data. If some of the certain m sections do not exist in some PE files, the feature vectors corresponding to these sections are 0, that is, Hi=[0, 0, . . . , 0].

Step 304: Perform a normalization processing on the m feature vectors obtained in step 303, to obtain m normalized feature vectors, which are recorded as H̅ᵢ=[ h̅₀, h̅₁, . . . , h̅₂₅₅], where a function used for the normalization processing is

$${\overline{h}}_{i} = \frac{{h}_{i}}{{\sum }_{0 \leq i \leq 255} {h}_{i}} , \\ 0 \leq i \leq 255.$$

Step 305: Adjust ranges of the normalized m feature vectors.

The ranges of the m feature vectors may be adjusted by, but not limited to, the following two manners:

(1) In the kernel space mapping method, a distance measurement manner between the feature vectors is converted into a distance measurement manner of kernel spaces, which includes:

the computer may select an appropriate kernel space such as a polynomial kernel, a radial basis function (RBF) kernel, a χ² kernel, or an intersection kernel. Then a mapping function of the selected kernel space is used to obtain kernel space vectors \tilde{H}ᵢ=[\tilde{h}₀, \tilde{h}₁, . . . , \tilde{h}₂₅₅], i=1, . . . , m in the selected kernel space corresponding to the m feature vectors. The mapping function of the selected kernel space may be:

$${Φ}_{j} ( x ) = \{ \begin{matrix}\sqrt{{x}^{γ} {κ}_{0}} , & j = 0 \\ \sqrt{2 {x}^{γ} {κ}_{\frac{j + 1}{2}}} cos ( \frac{j + 1}{2} L log x ) , & j is an odd number \\ \sqrt{2 {x}^{γ} {κ}_{\frac{j}{2}}} sin ( \frac{j}{2} L log x ) , & j is an even number\end{matrix}$$

In the mapping function of the kernel space, j is an integer between 1 and 2n, and the computer may determine an order n, where a higher order indicates more items and higher precision of the mapping function. L=2π/Λ, where Λ indicates a selected period; kⱼ is truncation of a window function of inverse Fourier transformation k(ω) of a kernel signature corresponding to the kernel space, kⱼ=tⱼL(ω*k)(jL) and

$${t}_{j} = \{ \begin{matrix}1 & \vert j \vert \leq ( n - 1 ) / 2 \\ 0 & in other cases\end{matrix} ,$$

where * indicates a convolution, and w indicates a frequency domain of the selected window function; and γ in the foregoing mapping function is determined by the kernel function itself of the selected kernel space and may satisfy k(cx, cy)=c^{γ}K(x, y), where c is a constant.

Therefore, in the kernel space, the kernel space vectors corresponding to the m feature vectors are obtained by using the mapping function, which are: \tilde{H}i=[Φ₀( h̅₀, Φ₁( h̅₀), . . . , Φ₂ₙ( h̅₀), . . . , Φ₀( h̅₂₅₅), Φ₁( h̅₂₅₅), . . . , Φ₂ₙ( h̅₂₅₅)], where i=1, . . . , m.

The foregoing kernel function is a function satisfying Mercer's theorem. Assuming that there are vectors x and y on an n-dimensional space R, and the vectors x and y are mapped to an m-dimensional kernel space F by using a mapping function Φ(x), to obtain corresponding vectors Φ(x) and Φ(y) on the kernel space F. A kernel function K(x, y) satisfies K(x, y)=<Φ(x), Φ(y)>(sign <,> indicates an inner product). If the kernel function K(x, y) is expressed as

$$η ( w ) = K ( {e}^{- ω / 2} , {e}^{ω / 2} ) , \\ ω = log ( \frac{y}{x} ) ,$$

η(w) is referred to as a kernel function signature of the kernel function.

For example, when the computer selects an intersection kernel, the kernel function of the kernel space is K(x, y)=Σᵢⁿmin(xᵢ, yᵢ), γ=1. An order n is selected, for example, n=1; an approximate period Λ=a log(n+b)+c is calculated (in the case that the period Λ is guaranteed to be greater than 0, a, b, and c may be selected randomly, for example, a=2.0, b=0.99, and c=3.52); the kernel function of the intersection kernel is calculated as

$$k ( ω ) = \frac{2}{π ( 1 + 4 {ω}^{2} )} ;$$

and a rectangular window is selected to perform truncation on k(ω), and the specific form of w of the rectangular window is

$$w = \{ \begin{matrix}\frac{2 sin ωΛ / 2}{ωΛ} & ω \neq 0 \\ 1 , & ω = 0\end{matrix} .$$

Therefore, the mapping function of the selected intersection kernel may be obtained and the mapping of the kernel space may be performed according to these calculated parameters.

(2) If the weighted operation method is used, the distance measurement manner between the feature vectors is narrowed by using a weighted value, which includes: multiplying the m normalized feature vectors H̅ᵢ by a weighted value α, that is, [symbol] ᵢ=α H̅ᵢ. The larger an entropy value of H̅ᵢ, the larger α.

For example, H_{S} is the entropy value of H̅ᵢ, that is,

$${H}_{s} = - {\sum }_{i = 0}^{255} {\overline{h}}_{i} {log}_{2} ( {\overline{h}}_{i} ) ,$$

and the weighted value α may be:

$$α = \{ \begin{matrix}0.0007 {( {H}_{s} - 0.5 )}^{4} + 1 , & {H}_{s} \geq 0.5 \\ 1 , & in other case\end{matrix} .$$

Step 306: Calculate the information fingerprints sigᵢ, i=1, . . . , m of the m feature vectors obtained by performing the range adjustment separately.

The computer may select a function used for calculating the information fingerprint to calculate the information fingerprints relevant to the m feature vectors. Taking an information fingerprint calculation function as an example, this embodiment includes: for m range-adjusted feature vectors \tilde{H}ᵢ obtained by using the kernel space mapping method in step 305:

(1) the computer selects m thresholds σ₁, σ₂, . . . , σₘ and digits f_{1′}, f_{2′}, . . . , fₘ of the information fingerprints;
(2) fᵢ points Pᵢ=(p₀, p₁, . . . , p₂₅₆₍₂ₙ₊₁₎₋₁) are taken as samples from a 256(2n+1)-dimensional Gaussian distribution function of which an expected value is 0 and a standard deviation is σᵢ;
(3) fᵢ points Bᵢ are taken as samples from a uniform distribution function on [0, 2π];

(4) fᵢ points Tᵢ are taken as samples from a uniform distribution function on [−1, 1]; and
(5) the information fingerprints of the m range-adjusted feature vectors are:

sigᵢ=[sgn(cos(P₁·\tilde{H}₁+B₁)+T₁, . . . ,sgn(cos(P_{fi}·\tilde{H}_{fi}+B_{fi})+T_{fi}]

where i=1, . . . , m, the sign · indicates an inner product, and sgn is a sign function

$$sgn ( x ) = \{ \begin{matrix}0 , & x < 0 \\ 1 , & x \geq 0\end{matrix} .$$

It should be noted that if the m range-adjusted feature vectors [symbol] ᵢ are obtained by using the weighted method, the method for calculating the information fingerprints is similar to the foregoing method for calculating the information fingerprints, which is not described herein.

Step 307: Obtain information fingerprint of the PE file to be processed, according to the information fingerprints of the m range-adjusted feature vectors calculated in step 306. Specifically, the information fingerprint of each range-adjusted feature vector may be spliced, that is SIG=[sig₁, sig₂, . . . , sigₘ].

Step 308: Output PE files with the same information fingerprint as a cluster.

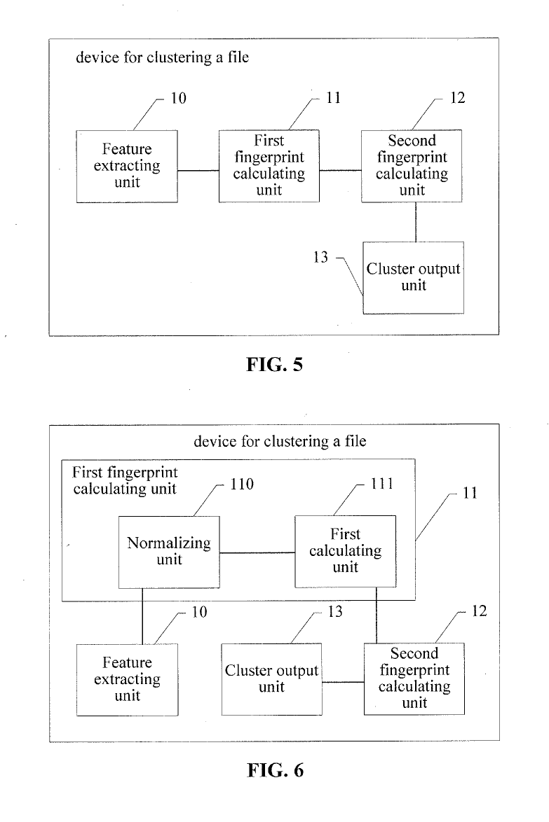

An embodiment of the present disclosure also provides a device for clustering the file. The schematic structural diagram of the device is shown in FIG. 5, and which includes following units.

A feature extracting unit 10 is configured to extract a feature from each of multiple information blocks in a respective file to be processed. Optionally, the feature extracting unit 10 may extract data distribution information from the multiple information blocks separately, where the data distribution information includes frequencies or quantities of some or all data in the information blocks.

A first fingerprint calculating unit 11 is configured to calculate an information fingerprint of the feature of each information block of the multiple information blocks, where the feature is extracted by the feature extracting unit 10.

A second fingerprint calculating unit 12 is configured to obtain an information fingerprint of the respective file to be processed, according to the information fingerprint of the feature of each information block calculated by the first fingerprint calculating unit 11.

A cluster output unit 13 is configured to output files to be processed, with the same information fingerprint calculated by the second fingerprint calculating unit 12, as a cluster.

It can be seen that in the clustering device provided in the embodiment of the present disclosure, when the files to be processed are clustered, the cluster output unit 13 may process the information fingerprints of the features of the multiple information blocks included in the files to be processed, to obtain the information fingerprints of the files to be processed, and then compares the information fingerprints to determine the files to be processed with the same information fingerprint as a cluster, so as to implement the file clustering. Therefore, the information fingerprints are used to identify the features of the information blocks in the files to be processed, and the files to be processed are clustered according to identifiers. Compared with the existing technology using similarity comparisons, the method for calculating the identifier of the feature to perform the clustering in the embodiments of the present disclosure significantly reduces the data to be calculated and the degree of complexity.

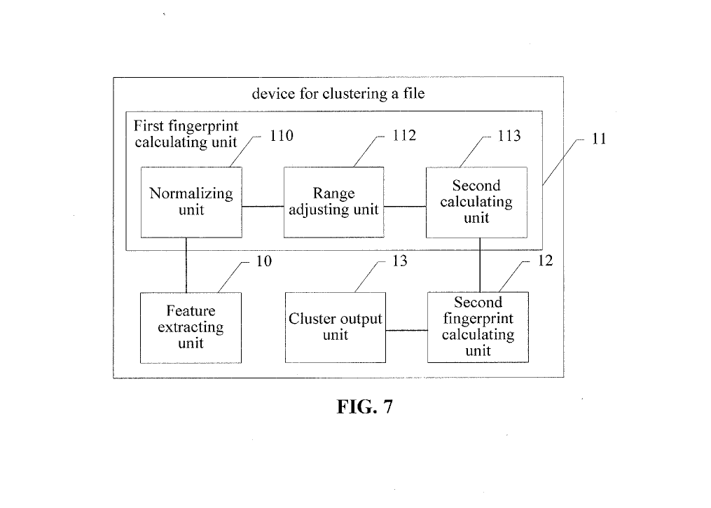

Referring to FIG. 6 and FIG. 7, in an embodiment, the file clustering device includes the structure shown in FIG. 5, and the first fingerprint calculating unit 11 therein may be implemented by a normalizing unit 110 and a first calculating unit 111.

The normalizing unit 110 is configured to normalize the feature of each information block of the multiple information blocks extracted by the feature extracting unit 10.

The first calculating unit 111 is configured to calculate an information fingerprint of the feature of each information block, where the feature is normalized by the normalizing unit 110. The first calculating unit 111 may calculate the information fingerprint of the feature of each information block according to a function for calculating the information fingerprints directly. Then, the second fingerprint calculating unit 12 determines the information fingerprints of the files to be processed according to the information fingerprints corresponding to the features of the information blocks calculated by the first calculating unit 111. Optionally, the first calculating unit 111 may be implemented by using a range adjusting unit 112 and a second calculating unit 113.

The range adjusting unit 112 is configured to adjust a range of the feature of each information block, where the feature is obtained by normalized by the normalizing unit 110. The range adjusting unit 112 may map the normalized feature of each information block to the kernel space corresponding to the mapping function, according to a mapping function of a kernel space, where information blocks with the same attribute in different files to be processed use the same mapping function; and/or the range adjusting unit 112 may perform a weighted operation on the normalized feature of each information block.

The second calculating unit 113 is configured to calculate the information fingerprint of the feature of each information block, where the feature is obtained by performing the range adjustment by the range adjusting unit 112. Then the second fingerprint calculating unit 12 determines the information fingerprints of the files to be processed, according to the information fingerprints which correspond to the features of the information blocks and are calculated by the second calculating unit 113.

Each unit in the foregoing file clustering device may perform file clustering according to the foregoing method.

A person of ordinary skill in the art may understand that all or some steps in each method of the foregoing embodiments may be implemented by a program instructing relevant hardware. The program may be stored in a computer-readable storage medium. The storage medium may include: a read-only memory (ROM), a random access memory (RAM), a magnetic disk, or an optical disc.

A file clustering method and device provided in the embodiments of the present disclosure are described above in detail. Specific examples are used in this specification to describe the principle and implementation manners of the present disclosure, but the foregoing descriptions of the embodiments are merely intended to facilitate understanding of the method and core idea of the present disclosure. Besides, a person of ordinary skill in the art may make alterations to the specific implementation manners and application scope according to the idea of the present disclosure. In conclusion, the content of this specification shall not be understood as a limitation on the present disclosure.

What is claimed is:

1. A method for clustering a file, comprising:
extracting, by a computer, a feature from each of multiple information blocks in a respective file to be processed;
calculating, by a computer, an information fingerprint of the extracted feature of each information block of the multiple information blocks;
obtaining, by a computer, an information fingerprint of the respective file to be processed, according to the information fingerprint of the feature of each information block; and
outputting, by a computer, files to be processed with the same information fingerprint, as a cluster.

2. The method according to claim 1, further comprising:
extracting data distribution information of the multiple information blocks in the respective file to be processed, wherein the data distribution information comprises frequencies or quantities of some or all data in the information blocks.

3. The method according to claim 1, further comprising:
normalizing the extracted feature of each information block of the multiple information blocks; and
calculating an information fingerprint of the normalized feature of each information block.

4. The method according to claim 3, further comprising:
adjusting a range of the normalized feature of each information block; and
calculating an information fingerprint of the feature, the range of which is adjusted, of each information block.

5. The method according to claim 4, further comprising:
mapping, according to a mapping function of a kernel space, the normalized feature of each information block to the kernel space corresponding to the mapping function, wherein information blocks with the same attribute in different files to be processed use the same mapping function.

6. The method according to claim 4, further comprising:
performing a weighted operation on the normalized feature of each information block.

7. A device for clustering a file, comprising:
a feature extracting unit that extracts a feature from each of multiple information blocks in a respective file to be processed to obtain an extracted feature;
a first fingerprint calculating unit that calculates an information fingerprint of the extracted feature of each information block of the multiple information blocks;
a second fingerprint calculating unit that obtains an information fingerprint of the respective file to be processed, according to the information fingerprint of the feature of each information block; and
a cluster output unit that outputs files to be processed with the same information fingerprint, as a cluster.

8. The device according to claim 7, wherein
a features extracted by the feature extracting unit is data distribution information of the multiple information blocks, wherein the data distribution information comprises frequencies or quantities of some or all data in the information blocks.

9. The device according to claim 7, wherein the first fingerprint calculating unit comprises:
a normalizing unit that normalizes the extracted feature of each information block of the multiple information blocks to achieve a normalized feature; and
a first calculating unit that calculates an information fingerprint of the normalized feature of each information block.

10. The device according to claim 9, wherein the first calculating unit comprises:
a range adjusting unit that adjusts a range of the normalized feature of each information block; and
a second calculating unit that calculates an information fingerprint of the feature the range of which has been adjusted, of each information block.

11. The device according to claim 10, wherein the range adjusting unit, according to a mapping function of a kernel space, maps the normalized feature of each information block to the kernel space corresponding to the mapping function, and wherein information blocks with the same attribute in different files to be processed use the same mapping function.

12. The device according to claim 10, wherein the range adjusting unit performs a weighted operation on the normalized feature of each information block.

13. A non-transitory computer storage medium comprising a computer executable instruction, wherein the computer executable instruction is adapted to perform a method for clustering a file, comprising:
extracting a feature from each of multiple information blocks in a respective file to be processed to obtain an extracted feature;
calculating an information fingerprint of the extracted feature of each information block of the multiple information blocks;
obtaining an information fingerprint of the respective file to be processed, according to the information fingerprint of the feature of each information block; and
outputting files to be processed with the same information fingerprint, as a cluster.

14. The non-transitory computer storage medium according to the claim 13, further comprising:
extracting data distribution information of the multiple information blocks in the respective file to be processed, wherein the data distribution information comprises frequencies or quantities of some or all data in the information blocks.

15. The non-transitory computer storage medium according to the claim 13, further comprising:
normalizing the extracted feature of each information block of the multiple information blocks to obtain a normalized feature; and
calculating an information fingerprint of the normalized feature of each information block.

16. The non-transitory computer storage medium according to the claim 15, further comprising:
adjusting a range of the normalized feature of each information block; and
calculating an information fingerprint of the feature, the range of which has been adjusted, of each information block.

17. The non-transitory computer storage medium according to the claim 16, further comprising:
mapping, according to a mapping function of a kernel space, the normalized feature of each information block to the kernel space corresponding to the mapping function, wherein information blocks with the same attribute in different files to be processed use the same mapping function.

18. The non-transitory computer storage medium according to the claim 16, further comprising:
performing a weighted operation on the normalized feature of each information block.
